(19) United States
(12) Patent Application Publication
(10) Pub. No.: US 2003/0192868 A1
(43) Pub. Date: Oct. 16, 2003

(54) Method for determining the accuracy of processing machines

(76) Inventors: Stefan Dietrich, Karlsruhe (DE); Matthias Hauth, Stutensee (DE); Juergen Pflaum, Bruchsal (DE)

Correspondence Address: HARNESS, DICKEY & PIERCE, P.L.C., P.O.BOX 8910, RESTON, VA, 20195, US

(21) Appl. No.: 10/366,384

(22) Filed: Feb. 14, 2003

(30) Foreign Application Priority Data
Feb. 14, 2002 (DE) 102 06 183.1

(51) Int. Cl. B23K 26/02

(52) U.S. Cl. 219/121.83

(57) ABSTRACT

A method is for determining the accuracy of processing machines, in which the provision of test marks on a test object and the recording of the spatial position of the test marks are carried out at the same point in relation to the processing machine. Each test mark is provided as close as possible to a predetermined position, known as the relative setpoint position, the spatial position of which in relation to a reference mark is exactly known. The accuracy verification takes place by the relative position of the test mark provided in relation to a corresponding reference mark being recorded and consequently the relative actual position of the test mark being determined. The deviation between the relative setpoint position and the relative actual position is a measure of the accuracy of the processing machine. The measuring between the setpoint position and the actual position preferably takes place by an image acquisition device, which has a camera arranged on the processing machine. This allows the accuracy verification to be carried out directly by the processing machine.

The present application hereby claims priority under 35 U.S.C. §119 on German patent application number DE 10206183.1 filed Feb. 14, 2002, the entire contents of which are hereby incorporated herein by reference.

### FIELD OF THE INVENTION

The invention generally relates to a method for determining the accuracy of processing machines, in particular of laser processing machines.

### BACKGROUND OF THE INVENTION

Precision machining or processing of objects using laser processing machines requires regular checking of the accuracy with which the laser beams used for the processing are directed onto the object to be processed. When verifying accuracy in such a way, it is customary within a test program for a test object to be processed in such a way that what are known as test markings are provided at predetermined points. Since a certain amount of material is removed each time from the test object during material processing by use of laser beams, the provision of test marks is also referred to as structuring the test object with test marks. Once the test marks have been structured, the test object is removed from the laser processing machine and measured by what is known as a measuring machine. In it, the exact spatial positions of the test markings provided are recorded, and consequently the accuracy of the laser processing machine is determined. In this case, the deviation of the actual position from the set-point position of a test marking is a direct measure of the accuracy of the laser processing machine. Usually used as a test object is what is known as a test plate, which is produced either from glass or from printed circuit board material. A test plate made of printed circuit board material is used in particular whenever the laser processing machine of which the accuracy is to be determined is intended for structuring, drilling or otherwise processing printed circuit boards.

The conventional method described above for determining the accuracy of laser processing machines has the disadvantage that, for accuracy to be verified precisely, the test object must be at least approximately at the same temperature during structuring and during measuring, on account of unavoidable thermal expansion. The measured accuracy of the laser processing machine is also dependent both on the type of test program used and on the measuring method applied. This dual dependence has the effect of reducing the precision of the accuracy verification.

### SUMMARY OF THE INVENTION

An embodiment of the invention is consequently based on an object of providing a method for determining the accuracy of laser processing machines which makes it possible for the accuracy of laser processing machines to be verified precisely and quickly.

An embodiment of the invention is based on the perception that the recording of the test mark and the reference mark by use of an image acquisition device takes place immediately after the provision of the test mark on the test object, the test object being kept at the same point between providing the test mark and recording the two marks. This creates the possibility of carrying out the accuracy verification without using a special measuring device. The spatially fixed arrangement of the test object during the entire method according to the invention also has the advantage that the influence of temperature fluctuations, which can scarcely be avoided when using a separate measuring device, is considerably reduced and consequently the precision with which the accuracy of the processing machine can be determined is distinctly increased.

The spatial position of the predetermined position at which the test mark is to be provided (setpoint position) may be fixed in relation to the position of the reference mark. Consequently, the determination of the accuracy of the processing machine is made possible on the basis of the relative position between the position of the test mark (actual position) and the position of the reference mark.

In an advantageous way, a camera which is arranged directly or indirectly on the processing machine may be used for the image acquisition device. This has the advantage that no modifications have to be made for carrying out the accuracy verification of the processing machine, with the result that the accuracy of the processing machine can regularly be determined at short time intervals, without causing long downtimes for the processing machine. Frequent checking of the accuracy of the processing machine then has the result that the precision of the processing over a lengthy production run can be ensured at a high level. It is pointed out that, in addition to the image acquisition device, an illuminating device may also be arranged on the processing machine, which illuminating device is designed in such a way that fast and accurate recording of the test mark and the reference mark is ensured.

The test mark may not be provided on the same object as that on which the reference mark is already located. The use of a special reference object on which one or a plurality of reference marks are provided at exactly defined points has the advantage that the accuracy verification of the processing machine can be carried out at low cost, since one and the same reference object can be used for a number of accuracy determinations.

The spatial position between the reference object and the test object may be fixed before the determination of the accuracy of the processing machine and retained throughout the entire method for accuracy determination. This has the advantage that the accuracy verification procedure in the processing machine can be automated. This avoids operator errors when carrying out the accuracy verification.

According to an embodiment of the invention, the test object and the reference object are designed in such a way that the test mark can be provided without the reference object having an influence and that the reference mark can be recorded without the test object having an influence. This can be achieved for example by (a) the test object being transparent or provided with holes at certain points in the event that the test object is arranged above the reference object. In this case, the holes must be distributed on the test object in such a way that the reference mark can be picked up by the camera of the image acquisition device.

In the event that (b) the test object is arranged underneath the reference object, there are two possible ways in which the accuracy verification can be advantageously carried out. The first possible way (b1) is to use a transparent reference object, which the processing laser beams can penetrate as far as possible without absorption and consequently can process the test object lying underneath as unhindered as possible. Suitable in particular in this case as a reference object is an object produced from glass, which apart from a highest possible transmission coefficient for the processing laser radiation, preferably also has a low thermal expansion. However, a material which is not transparent in the entire spectral range but is transparent only for at least one spectral range containing the wavelength of the processing laser beams may also be used for the reference object.

The second possible way (b2) of carrying out the accuracy verification is for the reference object to have holes or openings at suitable points, so that the processing laser beams can penetrate through these holes and consequently the test marks can be provided on the test object unhindered.

### BRIEF DESCRIPTION OF THE DRAWINGS

Further advantages and features of the present invention emerge from the following description by way of example of a currently preferred embodiment.

FIG. 1 shows the arrangement of reference marks and test marks in the entire working area of a laser processing machine and

FIG. 2 shows a detail of the working area represented in FIG. 1.

### DETAILED DESCRIPTION OF THE PREFERRED EMBODIMENTS

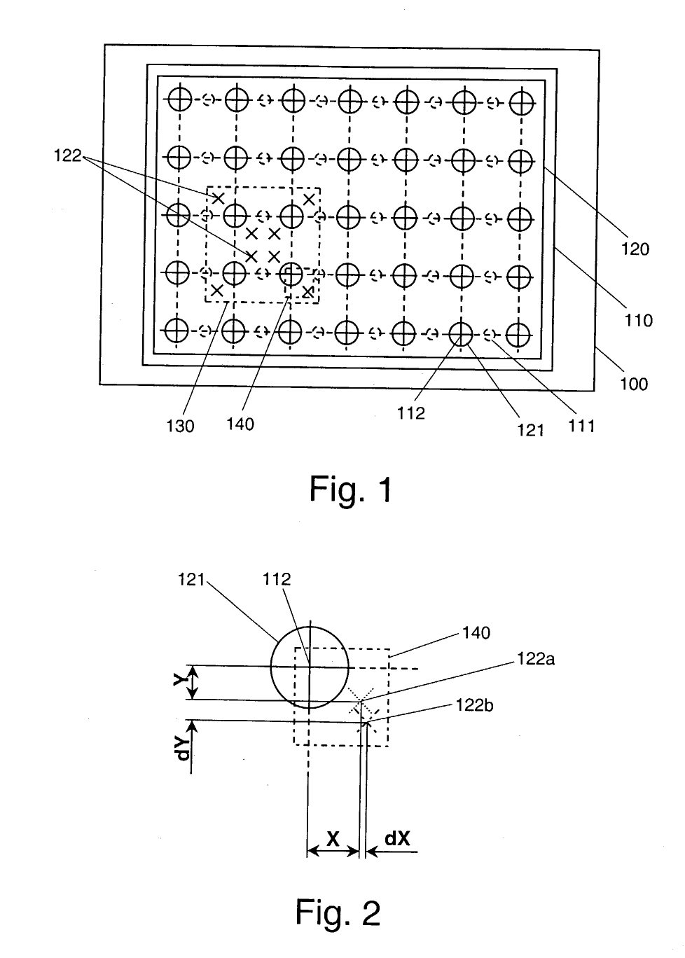

FIG. 1 shows a plan view of a complete processing area of a laser processing machine for which accuracy verification is carried out according to an exemplary embodiment of the invention. On a vacuum table 100 lies a reference plate 110, which is sucked firmly onto the vacuum table 100 by a negative pressure, which is generated by a multiplicity of suction channels (not represented) formed on the vacuum table 100. Above the reference plate 110 lies a test plate 120. The fixing of the test plate 120 in relation to the reference plate 110 and in relation to the vacuum table 100 is ensured by the reference plate 110 having a multiplicity of vacuum through-holes 111, through which the negative pressure transferred by the suction channels of the vacuum table 100 can be applied to the underside of the test plate 120. The fixing of the test plate 120 and of the reference plate 110 on the vacuum table 100 by means of negative pressure has the advantage that the negative pressure can be quickly applied and also quickly switched off again by switching corresponding pressure valves, with the result that the reference plate 110 and the test plate 120 can be fixed on the vacuum table quickly and reliably and removed again from the vacuum table 100 similarly quickly.

It is pointed out that other temporary fastening methods, such as for example clamping, screwing, adhesive bonding or magnetic fixing, may also be used for the spatial fixing of the reference plate 110 and the test plate 120. Similarly, it is conceivable for the reference plate 110 and the test plate 120 simply to be placed one on top of the other, in which case, to avoid an unwanted change in position, attention should be paid not only to a mounting that has as little vibration as possible but also to a certain minimum weight of the plate lying on top and a high coefficient of static friction between the two plate surfaces facing each other.

According to the exemplary embodiment represented in FIG. 1, on the reference plate 110 along with the vacuum through-holes 111 there are a plurality of reference marks 112, which are arranged on a square grid. It is pointed out in this connection that the reference marks 12 can of course be provided on the reference plate 110 in any other desired arrangement. The test plate 120, which is produced from an opaque material, has a multiplicity of bores 121, which are arranged in such a way that, given a corresponding relative position between the reference plate 110 and the test plate 120, the reference marks 112 provided on the reference plate 110 can be seen.

The accuracy determination of the laser processing machines is carried out within a selected working area 130, in which a series of test marks 122 are provided by the processing laser beams on the test plate 120. Each test mark 122 is in this case provided as close as possible to a predetermined set-point position, which is predetermined in relation to the corresponding reference mark. The accuracy verification of the laser processing machine then takes place by the test mark 122 provided being recorded together with the corresponding reference mark 112 within an image acquisition area 140 by use of an image acquisition device (not represented).

FIG. 2 shows the image acquisition area 140 in an enlarged representation. In addition to the elements which are already represented in FIG. 1, and which are denoted by the same reference numerals, the set-point position 122a for the test mark 122 is represented in FIG. 2. The set-point position 122a is predetermined by the control of the laser processing machine. The spatial position of the set-point position 122a is accurately determined in relation to the reference mark 112. The test mark 120 is then provided by the laser processing device at an actual position 122b. The distance between the reference mark 112 and the predetermined set-point position 122a for the test mark 122 to be provided is represented in the x direction by the distance x and in the y direction, perpendicular thereto, by the distance y. The distance of the actual position 122b from the set-point position 122a, determining the accuracy of the laser processing machine, is illustrated by the two distances dx and dy, which indicate the inaccuracy of the laser processing in the x direction and in the y direction.

To sum up, an embodiment of the invention provides a method for determining the accuracy of processing machines, in particular of laser processing machines, in which the provision of test marks 122 on a test object 120 and the recording of the spatial position of the test marks 122 are carried out at the same point in relation to the processing machine. According to an embodiment of the invention, each test mark 122 is provided as close as possible to a predetermined position, known as the relative set-point position 122a, the spatial position of which in relation to a reference mark 112 is exactly known. The accuracy verification of the processing machine takes place by the relative position of the test mark 122 provided in relation to a corresponding reference mark 112 being recorded and consequently the relative actual position 122b of the test mark 122 being determined. The deviation between the relative set-point position 122a and the relative actual position 122b of the test mark 122 provided is a measure of the accuracy of the processing machine. The measuring between the set-point position 122a and the actual position 122b takes place by an image acquisition device, which has a camera arranged directly or indirectly on the processing machine. This allows the accuracy verification to be carried out directly by the processing machine.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for determining the accuracy of a processing machine, comprising:
providing a test mark on a test object as close as possible to a predetermined position, using the processing machine;
recording the test mark and a reference mark using an image acquisition device;
determining a spatial position of the test mark in relation to the reference mark using an image processing system, wherein the recording of the test mark and the reference mark is carried out directly after at least one of the provision of the test mark and the provision of a plurality of test marks, and wherein the test object is maintained at the same point in relation to the processing machine during the recording of the test mark and the reference mark.

2. The method as claimed in claim 1, wherein the spatial position of the predetermined position is predetermined in relation to the reference mark.

3. The method as claimed in claim 1, wherein a camera, arranged at least one of directly and indirectly on the processing machine, is used as the image acquisition device.

4. The method as claimed in claim 1, wherein the reference mark is provided on a reference object.

5. The method as claimed in claim 4, wherein the reference object is brought into a fixed spatial position in relation to the test object before the provision of the test mark and is kept in this fixed spatial position at least until after the recording of the test mark and the reference mark.

6. The method as claimed in claim 4, wherein the test and reference objects are designed in such a way that, the test mark is provided without influence from the reference object, and the reference mark is recordable without influence from the test object.

7. The method as claimed in claim 4, wherein a test plate is used as the test object and a reference plate is used as the reference object, the test plate and the reference plate being arranged one on top of the other with their surface areas in contact.

8. The method as claimed in claim 5, wherein the fixed spatial position between the test object and the reference object is ensured by one object being at least one of clamped, screwed, adhesively bonded, magnetically attracted and sucked by way of negative pressure onto the other object.

9. The method as claimed in claim 5, wherein the fixed spatial position between the test object and the reference object is ensured by one object being placed onto the other object.

10. The method as claimed in claim 1, wherein the method is for determining the accuracy of laser processing machines.

11. The method as claimed in claim 2, wherein a camera, arranged at least one of directly and indirectly on the processing machine, is used as the image acquisition device.

12. The method as claimed in claim 2, wherein the reference mark is provided on a reference object.

13. The method as claimed in claim 12, wherein the reference object is brought into a fixed spatial position in relation to the test object before the provision of the test mark and is kept in this fixed spatial position at least until after the recording of the test mark and the reference mark.

14. The method as claimed in claim 5, wherein the test and reference objects are designed in such a way that, the test mark is provided without influence from the reference object, and the reference mark is recordable without influence from the test object.

15. The method as claimed in claim 5, wherein a test plate is used as the test object and a reference plate is used as the reference object, the test plate and the reference plate being arranged one on top of the other with their surface areas in contact.

16. A method for determining the accuracy of a processing machine, comprising:
providing a test mark on a test object as close as possible to an existing position using the processing machine;
recording the test mark and a reference mark;
determining a spatial position of the test mark in relation to the reference mark, wherein the recording of the test mark and the reference mark is carried out directly after at least one of the provision of the test mark and the provision of a plurality of test marks, and wherein the test object is maintained at the same point in relation to the processing machine during the recording of the test mark and the reference mark.

17. The method as claimed in claim 16, wherein the spatial position of the existing position is determined in relation to the reference mark.

18. The method as claimed in claim 16, wherein a camera, arranged at least one of directly and indirectly on the processing machine, is used to record at least one of the test mark and reference mark.

19. The method as claimed in claim 16, wherein the reference mark is provided on a reference object.

20. The method as claimed in claim 19, wherein the reference object is brought into a fixed spatial position in relation to the test object before the provision of the test mark and is kept in this fixed spatial position at least until after the recording of the test mark and the reference mark.
